(19) United States
(12) Patent Application Publication
(10) Pub. No.: US 2008/0222320 A1
(43) Pub. Date: Sep. 11, 2008

(54) COMMUNICATION NODE APPARATUS, NETWORK SYSTEM HAVING THE COMMUNICATION NODE APPARATUS, AND DATA TRANSMITTING SYSTEM

(75) Inventor: Shigeru SUGANUMA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/042,683

(22) Filed: Mar. 5, 2008

(30) Foreign Application Priority Data
Mar. 7, 2007 (JP) 2007-057348

(51) Int. Cl. G06F 13/14

(52) U.S. Cl. 710/35

(57) ABSTRACT

Disclosed is a data transmission system in which a set of asymmetrical serial buses are formed by a set of multiplexed unidirectional buses and a reverse-direction sole serial bus. A synchronization signal is superimposed on the signal transmitted over each of the multiplexed unidirectional buses. The multiplexed unidirectional buses are used mainly for data transfer, and the reverse-direction sole serial bus is used for transmitting the control information, such as ACK response, to the data transfer.

### REFERENCE TO RELATED APPLICATION

This application is based upon and claims the benefit of the priority of Japanese patent application No. 2007-057348, filed on Mar. 7, 2007, the disclosure of which is incorporated herein in its entirety by reference thereto.

### FIELD OF THE INVENTION

This invention relates to a technique for data transmission. More particularly, this invention relates to a system, a communication node apparatus, a network and a method suited to data transmission employing a plurality of high-speed serial buses.

### BACKGROUND OF THE INVENTION

For data transmission in the insides of and between the information processing apparatus, the routine practice has frequently been to use parallel buses, by means of which the bandwidth may be increased in terms of the number of bits.

The serial bus has so far been used in general as a low-speed low-cost communication bus, inasmuch as the number of signal lines needed is small.

Recently, the network topology within the information processing apparatus is becoming complex, while the demand for a higher transfer capacity is increasing. For this reason, attempts have been made to increase a transfer clock rate, that is, to increase transfer rate, and bit width in the case of parallel buses. With the parallel buses, the problem of clock skew of transfer bit, for example, has come up to the surface under the effect of the increasing transfer clock rate. In addition, with the increasingly finer design rules of the circuit substrates, the effect of wiring delay has become non-negligible. These technical problems of the parallel buses arise because a clock is separated from a signal.

To cope with the problem of the increasing speed, attention is now directed to using a high-speed serial bus which transmits a synchronization signal and data in superposition with each other.

Among these high-speed serial buses, there are, for example, Fibre Channel, SERIAL-ATA, PdI Express and Infini-band.

These serial buses are constituted by symmetrical serial buses comprising a set of two unidirectional serial buses, one of which is used for transmission and the other of which is used for reception.

To provide for a broader band for transmission of the serial buses, a plurality of unidirectional serial buses may be connected and further a plurality of serial buses may be in operation in parallel to implement a multiplexed transfer function.

The principal protocol of, for example, the PCI Express, provides for an ACK response (response for acknowledgement) in which a response is transmitted in return for a data transfer in order to confirm that transfer has been done in a regular manner.

With a symmetrical bidirectional serial bus, if data is transmitted in a sole direction, the counterpart bus returns only the ACK response, which means wasteful use of the band. FIG. 8A shows an example of an ACK response in case of unidirectional data transfer with the multiplexing degree of 1.

FIG. 9A shows an example of an ACK response in the case of unidirectional data transfer with the multiplexing degree of 2. FIGS. 8A and 9A show the state in which, for data transfer on a serial bus Tx (transfer side), an ACK response is returned on the serial bus RX (receiving side) from a counterpart device.

In the case of bidirectional data transfer, an ACK response has to be returned to the transfer from the counterpart side, so that the ACK response is inserted between two data transfers, thus reducing the transfer band. FIG. 8B shows an example of an ACK response in case of bidirectional data transfer with the multiplexing degree of 1. FIG. 9B shows an example of an ACK response in case of bidirectional data transfer with the multiplexing degree of 2. FIGS. 8B and 9B show the state in which, for data transfer on a serial bus Tx (transfer side), an ACK response is returned on the serial bus RX (receiving side) from a counterpart device, and in which, for data transfer on the serial bus RX (receiving side) from the counterpart device, an ACK response is returned on the serial bus Tx (transmitting side).

Meanwhile, Patent Document 1 shows a configuration in which unidirectional data lines D1 to Dn, where n is an integer not less than unity, are provided from a transmitting device to a receiving device, and in which a sole unidirectional control line C1 is provided from the receiving device to the transmitting device. A transfer clock signal, generated by the receiving device, which has received a transfer request from the transmitting device, is transmitted over the control line C1 to the transmitting device, which then transmits data on the data lines D1 to Cn, using the transfer clock from the control line C1. It is stated that, in case no transfer clock is output from the receiving device on the control line C1, responsive to a transfer request from the transmitting device, the transmitting device may judge the receiving device to be busy, or inquire over the control line C1 whether or not the receiving device is in a receiving enabled state. With Patent Document 1, the receiving side generates a transfer clock and transmits the so generated transfer clock to the transmitting device, which then transmits data using the so received transfer clock. The technique disclosed in Patent Document 1 has no relevance to the high speed serial bus and is totally different from the concept of the present invention which may be applied with advantage to the high speed serial bus. On the other hand, Patent Document 2 shows a configuration in which a test device for a high speed serial bus according to, for example, the IEEE1394 standard, is not handled as a network node.

### [Patent Document 1]

JP Patent Kokai Publication No. JP-P2003-152745A

### [Patent Document 2]

JP Patent Kokai Publication No. JP-P2002-374254A

### SUMMARY OF THE DISCLOSURE

The following analyses are given by the present invention. The entire disclosure of the above mentioned patent documents are incorporated herein by reference thereto.

As mentioned above, if, in a symmetrical bidirectional serial bus, data is transmitted unidirectionally, the counterpart side bus returns only an ACK response. Hence, the band is not used to advantage.

On the other hand, if data is to be transmitted bidirectionally, an ACK response must be returned to data transmitted from the counterpart side. Hence, the ACK response is inserted between two data transmitted, thus lowering the transfer band. In particular, in the case of multiplexed transfer, all of the multiplexed buses need to be used, despite the fact that the response is mostly as short as a sole symbol, and transfer corresponding to the gap length is needed for synchronization, thus wastefully using the band.

Accordingly, it is an object of the present invention to provide a system, an apparatus and a method which, when applied to a protocol for returning a response to data transfer from a counterpart side in data transmission on a serial bus, may be effective to suppress lowering of the transfer band and deterioration in transmission performance.

It is another object of the present invention to provide a system, an apparatus and a method, which make it possible to construct a network system interconnecting a plurality of communication nodes, with a limited number of terminals, as coupling coefficients of the individual nodes are taken into account.

The configuration of the invention disclosed in the present application may be summarized substantially as follows.

A system according to the present invention is a data transmission system in which a plurality of unidirectional serial buses, each transmitting a signal, having a synchronization signal superimposed thereon, are used for signal transmission from a transmitting side to a receiving side with a multiplexing degree corresponding to the number of the plurality of unidirectional serial buses. A single unidirectional serial bus for transmitting a signal from the receiving side to the transmitting side is provided for controlling the signal transmission from the transmitting side to the receiving side over the plurality of unidirectional serial buses. The plurality of unidirectional serial buses from the transmitting side to the receiving side constitute a set of asymmetrical buses together with the single unidirectional serial bus from the receiving side to the transmitting side.

A communication node apparatus according to the present invention comprises: means for splitting the single information and for performing multiplexed transfer in which the divided information are transmitted in parallel, from a transmitting side to a receiving side, using a plurality of unidirectional serial buses, each transmitting a signal, on which is superimposed a synchronization signal, and means for receiving a control signal over a sole unidirectional serial bus. The control signal is transmitted over the sole unidirectional serial bus from the receiving side to the transmitting side to control the signal transfer from the transmitting side to the receiving side over the plurality of unidirectional serial buses. The plurality of unidirectional serial buses from the transmitting side to the receiving side and the sole unidirectional serial bus from the receiving side to the transmitting side constitute a set of asymmetrical serial buses.

A network system according to the present invention includes a plurality of the aforementioned communication nodes. These communication nodes are interconnected using the asymmetrical serial bus to provide for an asymmetrical connection configuration between the communication nodes.

A data transmission method according to the present invention comprises

transmitting signals using a plurality of unidirectional serial buses, each transmitting a signal, having a synchronization signal superimposed thereon, with a multiplexing degree corresponding to the number of the plurality of unidirectional serial buses from a transmitting side to a receiving side,

the receiving side transmitting on a unidirectional serial bus from the receiving side to the transmitting side, a control signal for controlling the signal transmission over the plurality of unidirectional serial buses from the transmitting side to the receiving side; and

the transmitting side receiving the control signal over the sole unidirectional serial bus from the receiving side to the transmitting side.

The plurality of unidirectional serial buses from the transmitting side to the receiving side constitute a set of asymmetrical buses together with the single unidirectional serial bus from the receiving side to the transmitting side.

The meritorious effects of the present invention are summarized as follows.

According to the present invention, it becomes possible to suppress the band or the performance from being deteriorated in case the present invention is applied to the protocol of returning a response to data transmission from a counterpart side in data transmission over a serial bus. This results from the use in the present invention of a set of asymmetrical serial buses constituted by a set of multiplexed unidirectional serial buses and a reverse-direction sole serial bus and, more specifically, from the use of multiplexed unidirectional serial buses mainly for data transfer and the use of a reverse-direction sole unidirectional serial bus for transfer of the control information. Since the ACK response to data transfer is transmitted over the reverse-direction sole unidirectional serial bus, routine data may be transmitted at a high speed without being affected by the ACK response.

Additionally, with the present invention, in which the asymmetrical serial bus is used, there is no necessity for the network topology to be symmetrical. Hence, it becomes possible to construct a network system which is made up of an interconnection of a large number of communication nodes, with a limited number of terminals, as the coupling coefficient of each individual node is taken into account.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTIONS OF THE DRAWINGS

FIG. 1 is a block circuit diagram illustrating the configuration of an example of the present invention.

FIG. 2 is a diagram for illustrating the data transfer operation of the example of the present invention.

FIG. 3 is a diagram for illustrating the data transfer operation of the example of the present invention.

FIG. 4 is a diagram showing the configuration of a first comparative case.

FIG. 5 is a diagram showing the configuration of a first example of the present invention.

FIG. 6 is a diagram showing the configuration of a second comparative case.

FIG. 7 is a diagram showing the configuration of a second example of the present invention.

FIGS. 8A and 8B are diagrams for illustrating an example of the data transfer operation on symmetrical serial buses of a related art.

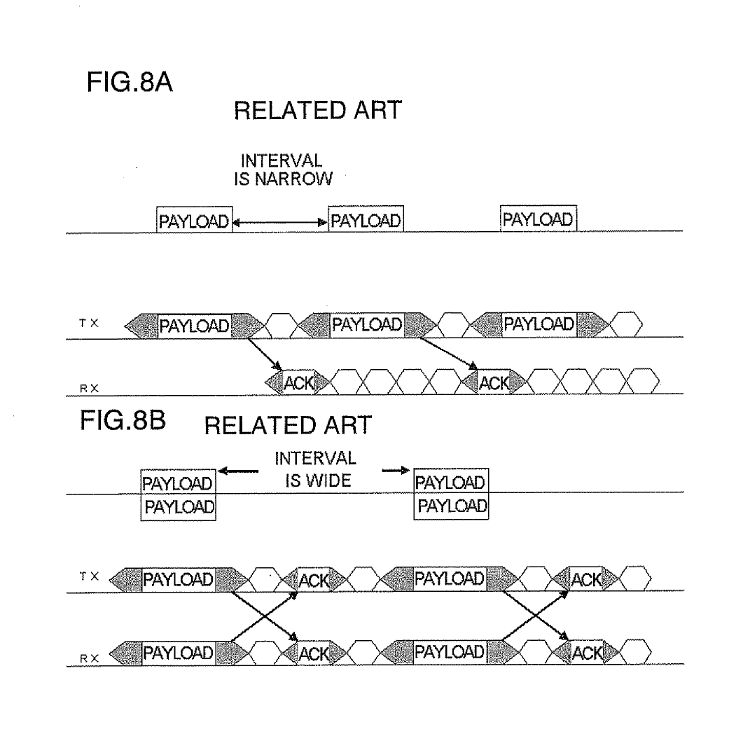

FIGS. 9A and 9B are diagrams for illustrating an example of the data transfer operation on symmetrical serial buses of a related art.

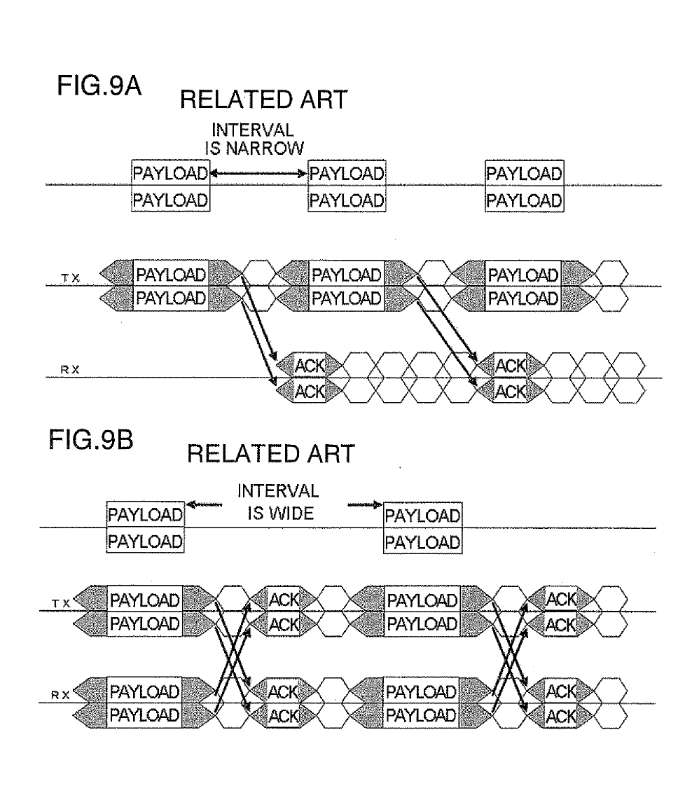

### PREFERRED MODES OF THE INVENTION

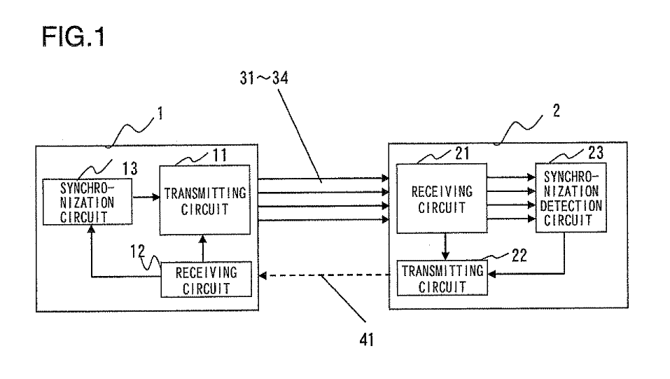

The present invention will now be described in further detail with reference to the accompanying drawings. FIG. 1 is a diagram showing the configuration of an example of the present invention. It is noted that FIG. 1 is for a case with a multiplexing degree of the serial bus equal to four.

A transmitter (transmitting device) 1 is connected to a receiver (receiving device) 2 by data buses 31 to 34, serving as data outputting buses. These data buses are each a unidirectional serial bus. The receiver 2 is connected to the transmitter 1 by a control bus 41, which is also a unidirectional serial bus. The plurality of unidirectional serial buses, with the multiplexing degree equal to four, from the transmitter 1 to the receiver 2, and the unidirectional serial bus from the receiver 2 to the transmitter 1, constitute a single set of asymmetrical serial buses.

On each of the data buses 31 to 34, as serial buses, there is superimposed a synchronization signal on the unidirectional signal to transmit the unidirectional signal. The transmitter 1 includes a transmitting circuit 11 for transmitting data on the data buses 31 to 34, which are unidirectional serial buses.

A transmitting circuit 22 of the receiver 2 transmits, over the control bus 41, an ACK response to parallel transfer from the transmitter 1 of data with the multiplexing degree equal to four.

When the ACK response, transmitted by the receiver 2 over the control bus 41, is received by a receiving circuit 12 of the transmitter 1, a transmitting circuit 11 of the transmitter 1 performs parallel transfer of the next data, with the multiplexing degree equal to four.

In the present example, the receiver 2 further includes a synchronization detection circuit 23 that monitors the signals received over the data buses 31 to 34, which are unidirectional serial buses, and for detecting synchronization slip on the data buses. Meanwhile, the receiving circuit 21 of the receiver 2 includes a clock-and-recovery circuit, not shown, for reproducing (recovering) the clock and the data from the signals received over the data buses 31 to 34 which are unidirectional serial buses.

When the synchronization detection circuit 23 of the receiver 2 has detected the synchronization slip on the data buses 31 to 34, the transmitting circuit 22 of the receiver 2 transmits the control information for correcting the synchronization slip over the control bus 41 which is the reverse-direction serial bus.

When the receiving circuit 12 of the transmitter 1 has received the control signal for correcting the synchronization slip, transmitted from the receiver 2 over the control bus 41, a synchronization circuit 13 of the transmitter performs delay control of data transfer among the data buses 31 to 34 for synchronization among the data buses 31 to 34.

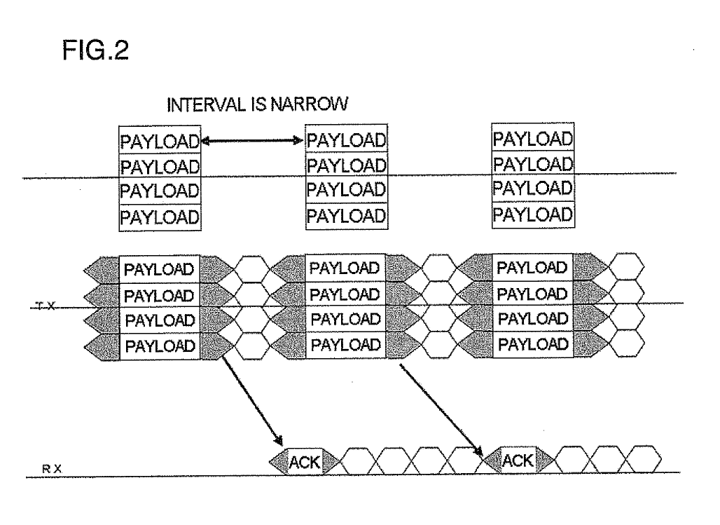

FIG. 2 schematically shows an example of data transfer employing the asymmetrical serial buses of FIG. 1. Referring to FIG. 2, a ACK response is transferred not on the data buses, but on a bus RX (unidirectional serial bus dedicated to reception), thus sufficiently exploiting the performance of the unidirectional transfer.

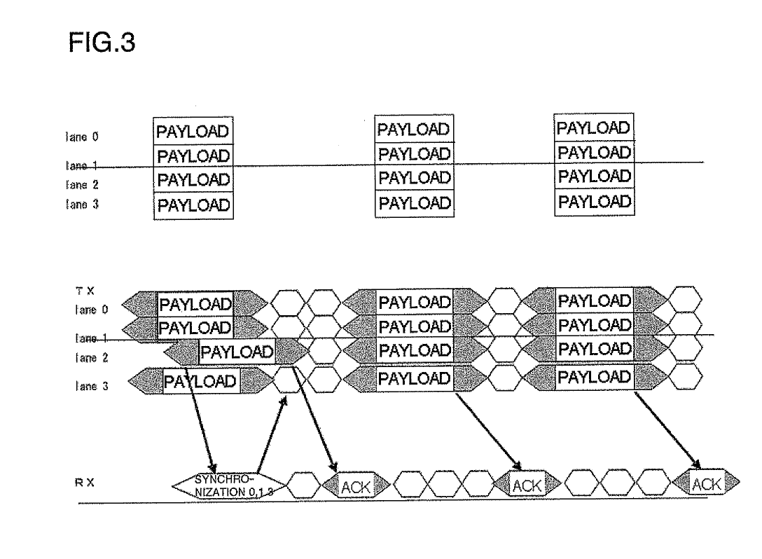

FIG. 3 schematically shows synchronization among the respective serial buses in the example shown in FIG. 1. Meanwhile, a bus TX has four lanes (lanes 0, 1, 2 and 3) respectively corresponding to the data buses 31 to 34, which are unidirectional serial buses.

It is assumed that, in FIG. 3, the lane 2 lags behind the other lanes (lanes 0, 1 and 3) by one character. On detection of the delay on the lane 2, the receiver 2 transmits, over the control bus 41, a control signal for commanding one-character transfer delay to the other lanes, that is, lanes 0, 1 and 3. See synchronization 0, 1 and 3′ on the bus RX of FIG. 3. On receipt of this control signal, the transmitter 1 synchronizes four lanes (lanes 0, 1, 2 and 3), by inserting an extra one-character gap in the lanes (lanes 0, 1 and 3), under control by the synchronization circuit 13.

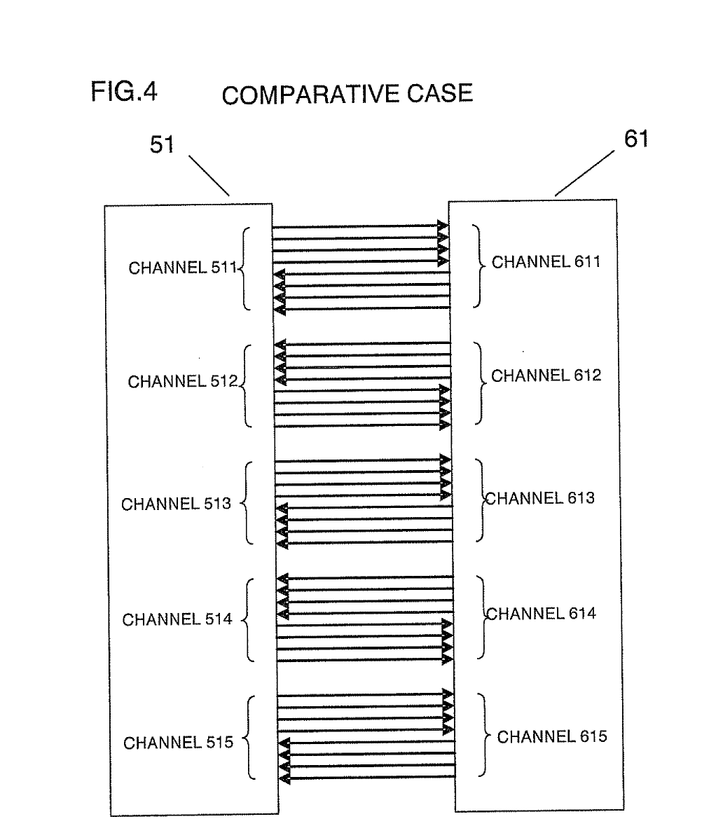

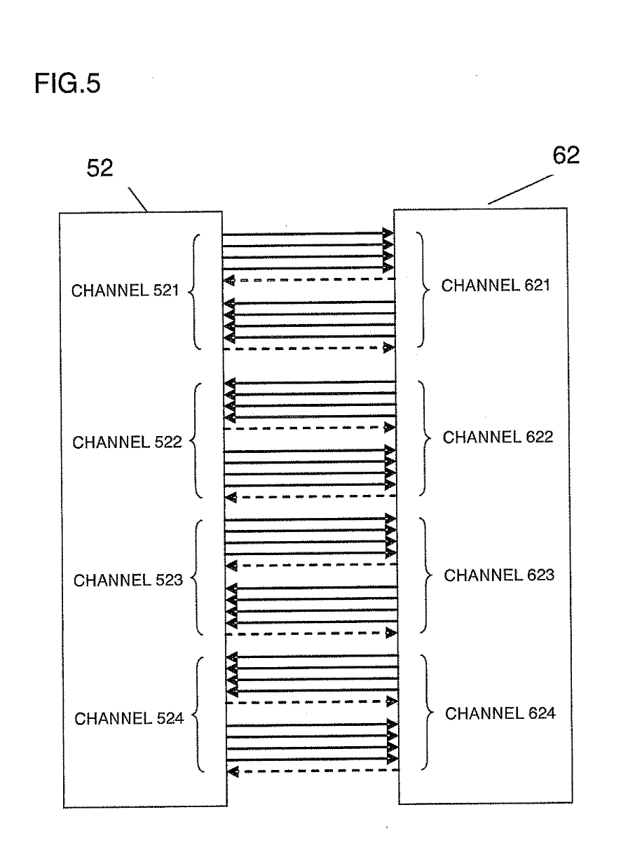

FIG. 4 shows the configuration employing symmetrical serial buses as a first comparative case, and FIG. 5 shows the configuration employing asymmetrical serial buses according to the present invention. The symmetrical serial bus configuration of FIG. 4 includes five sets of serial buses, with the multiplexing degree equal to four. In this comparative case, a transmitter/receiver 51 includes five channels 511 to 515, each composed of bi-directional serial buses with the multiplexing degree equal to four, and a transmitter/receiver 61 includes five channels 611 to 615, each composed of bidirectional serial buses with the multiplexing degree equal to four. The total number of the serial buses is 4×2×5=40.

In the asymmetrical serial bus configuration, shown in FIG. 5, there are provided four sets of asymmetrical serial buses for transmission and four sets of asymmetrical serial buses for reception, with each set having the multiplexing degree equal to four. A transmitter/receiver 52 includes four channels 521 to 524, for transmission and reception, whilst a transmitter/receiver 62 includes four channels 621 to 624, for transmission and reception. Each of these channels is constituted by a set of asymmetrical serial buses made up of multi-lane serial buses, with the multiplexing degree equal to four, and a serial bus for controlling the transfer in the reverse direction. The total number of the serial buses is (4+1)×2×4=40.

The bus transfer efficiency is now described. The transfer efficiency is expressed by the ratio of the amount of data actually transmitted on the serial buses to the amount of data to be transferred. In the data on the serial buses are included the header information to be appended to the data and the length of the gap to be inserted between the data, in addition to valid data (payload data).

On the symmetrical serial buses, ACK responses are inserted in the intervals between normal transfers. Hence, in the balanced input/output states, ACK transfers may be deemed to take place for every data transfer events. Therefore, the transfer efficiency S of the symmetrical serial buses may be represented by the equation (1):

$$\begin{matrix}Transfer efficiency S \\ ( Symmetric )\end{matrix} = \frac{\overbrace{( data length \div multiplexing degree )}^{original data length}}{\underbrace{\{ \vert ( \begin{matrix}T header length + \\ data length\end{matrix} ) + \begin{matrix}multiplexing \\ degree\end{matrix} \vert + gap length \}}_{real data length} + \underbrace{\{ \vert ( \begin{matrix}D header length + \\ ACK length\end{matrix} ) + \begin{matrix}multiplexing \\ degree\end{matrix} + \begin{matrix}gap \\ length\end{matrix} \}}_{real ACK length}} \qquad ( 1 )$$

On the asymmetrical buses, the ACK response is transferred on a separate path and hence does not affect the effective transfer length. Hence, the transfer efficiency A may be expressed by the following equation (2):

$$\begin{matrix}Transfer efficiency A \\ ( Asymmetric )\end{matrix} = \frac{\overbrace{( data length \div multiplexing degree )}^{original data length}}{\underbrace{\{ \vert ( \begin{matrix}T header length + \\ data length\end{matrix} ) \div \begin{matrix}multiplexing \\ degree\end{matrix} \vert + gap length \}}_{real data length}} \qquad ( 2 )$$

The actual transfer performance may be found by the following equation (3):

transfer efficiency=band (=performance of the bus itself)×transfer efficiency×multiplexing degree×channel

With the comparative case of FIG. 4, the following values are used as reference values of respective parameters of the transfer performance:
data length=32 char;
multiplexing degree=4;
gap length=3 char (IDLE, SKIP, SKIP);
T header length=4 char (SOT, TSN, CRC, END);
D header length=3 char (SOD, CRC, END);
ACK length=2 char (DLP, TSN);
number of channels=5 (×bidirectional);
performance of the bus itself=α;

Meanwhile, the above reference values of the parameters are merely illustrative and setting values other than those reference values may also be used.

For FIG. 5, the following values are used as reference values of respective parameters of the transfer performance:
data length=32 char
multiplexing degree=4
gap length=3 char (IDLE, SKIP, SKIP)
T header length=4 char (SOT, TSN, CRC, END)
D header length=3 char (SOD, CRC, END)
ACK length=2 char (DLP, TSN)
number of channels=4+4 (asymmetrical)
performance of the bus itself=α

To find the transfer performance, the respective values are substituted, and the following results are obtained:

$$\begin{matrix}Transfer efficiency S = α ( 32 \div 4 ) / \{ [ ( 4 + 32 ) \div 4 ] + 3 + [ ( 3 + 2 ) \div 4 ] + 3 \} \times ( 4 \times 5 \times 2 ) \approx 18.82 α & ( 4 ) \\ Transfer efficiency A = α ( 32 \div 4 ) / \{ [ ( 4 + 32 ) \div 4 ] + 3 \} \times ( 4 \times 4 \times 2 ) \approx 21.33 α \\ Hence , & ( 5 ) \\ transfer efficiency A > transfer efficiency S & ( 6 )\end{matrix}$$

With FIG. 4 of the comparative case, the number of the serial buses is the same as that of FIG. 5 of the present invention. However, in case the parameters are set as above, the transfer efficiency A for the present invention is better than the transfer efficiency S for the comparative case.

From the above equations (1) and (2), if transfer with a shorter data length is repeatedly carried out, the transfer efficiency represented by the equation (2) for the present invention becomes higher. In case transfer with longer data length is sustained, the transfer efficiency represented by the equation (1) for the comparative case becomes higher.

With PCI-Express, ACK responses for plural data transfers are combined together to a sole ACK and the transfer length for the sole ACK is elongated to prevent the transfer efficiency from being lowered. According to the present invention, such a control operation may be dispensed with by using a dedicated bus for the ACK responses.

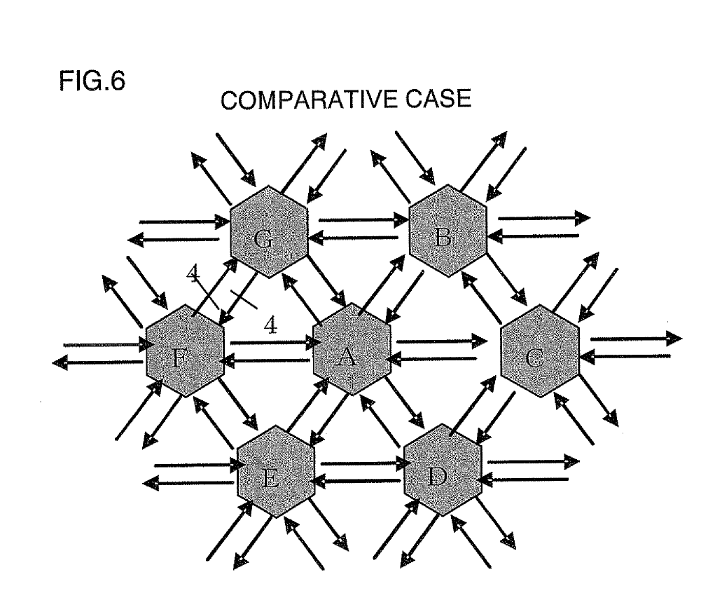

FIG. 6 is a diagram showing a network system of interconnecting a plural number of communication nodes, using symmetrical serial buses, as a comparative case to the present invention. In the case of FIG. 6, each line is constituted by serial buses having the multiplexing degree equal to four. To each communication node are connected 4×6=24 output serial buses and 24 input serial buses.

In the communication node, a plurality of items of data are transmitted in parallel over the plurality of unidirectional serial buses from the transmitting side, and a response signal to the data transfer is transferred from the receiving side to the transmitting side over the sole unidirectional serial bus. In the present example, a communication node, receiving signals transmitted from the transmitting side over the plurality of unidirectional serial buses, includes a synchronization detection means for monitoring signals and for detecting synchronization slip on the plurality of unidirectional serial buses. In case the synchronization slip is detected by the synchronization detection means, a control signal for correcting the synchronization slip on the plurality of unidirectional serial buses is transmitted to the transmitting side over the sole unidirectional serial bus from the receiving side to the transmitting side.

In the present example the transmitting side that receives the control information for correcting the synchronization slip synchronizes the signals transmitted from the transmitting side over the plurality of unidirectional serial buses.

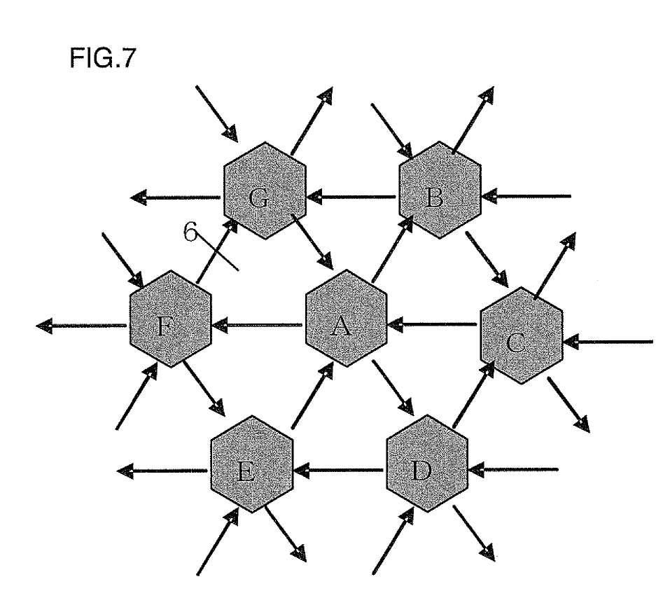

FIG. 7 shows an example of an asymmetrical network system employing the sets of asymmetrical serial buses according to the present invention. Each sole line is made up of data buses with the multiplexing degree equal to six and a reverse-direction control line with a multiplexing degree equal to unity. In FIG. 7, the reverse-direction control bus is dispensed with.

To each communication node, there are connected 6×3+1×3=21 output serial buses and 21 input serial buses.

In the case of FIG. 7, connection to an optional node is possible, depending on proper route selection. As compared to the comparative case of FIG. 6, it is possible to reduce the number of serial buses per communication node to construct a complex network system of a large size equivalent to the comparative case.

Thus, according to the present invention, in which the data buses and the control bus are provided independently of each other, it is possible to improve the data bus utilization efficiency to improve the data transfer capacity.

By allowing connection in only one direction, it becomes possible to construct a large-sized complex network system with a smaller number of resources. Specifically, 24+24=48 input/output lines are needed in the comparative case of FIG. 6, whereas 42 input/output lines suffice with FIG. 7.

In FIG. 7, the number of nodes to which direct outputting may be made is decreased. Hence, there is a possibility that the response time of FIG. 7 is deteriorated as compared to that of the comparative case of FIG. 6. However, FIG. 7 may exhibit characteristics superior to those of the comparative case insofar as the transfer band is concerned.

Referring to FIG. 6, the band needed for transfer from the node A to the node B will be explained. The transfer request to the node B includes not only the transfer request issued by the node A itself but the transfer request from the nodes D, E and F not directly connected to the node B. The transfer request from the node D to the node B includes not only the transfer request via the node A but also the transfer request via the node C. Hence, the amount of the actual transfer request is one-half the amount of the actual transfer request from the node D. The same may be said of the node F.

The amount of the transfer request between the nodes may be a function of the node-to-node distance, and hence is defined as a coupling coefficient ρ.

With an average transfer request (request band) βA−B from the node A to the node B, the transfer band βA−Btotal, needed for nodes A-B, is represented by the following equation (7):

βA−Btotal=βA−B+(½×βD−A−½×βF−A+βE−A)×ρ (7)

It is assumed that, with equal amounts of transfer requests between the respective nodes, the following equation (8) holds:

βA−B=β(=βD−A=βF−A=βE−A) (8)

The transfer band needed βA−Btotal may be expressed by the following equation (9):

βA−Btotal=β×(1+2×ρ) (9)

The transfer band needed between the nodes A-B in FIG. 7 is then derived. FIG. 7 differs from FIG. 6 in that transfer requests may also be made from the nodes C and E, and that the transfer request from the node F is via node E or via node G

The transfer request from the node C may be via node A or via other nodes. Hence, the band needed is ½. The same may be said of the request band from the node G.

The transfer request from node D may be via node C or via node E. Similarly to the transfer request from the node C itself, the transfer request via node C is ½. Hence, the band needed for the node D to the node A is ¾. The same may be said of the band needed for the node F.

Hence, the transfer band β′A−Btotal, needed between the nodes A-B, may be represented by the following equation (10):

$${β}^{′} A - Btotal = β A - B + ( 1 / 2 \times β C - A + 3 / 4 \times β D - A + β E - A + 3 / 4 \times β F - A + 1 / 2 \times β G - A ) \times ρ = β \times ( 1 + 3.5 \times ρ ) \qquad ( 10 )$$

The inventive configuration of FIG. 7 has a band 1.5 times that of the comparative case of FIG. 6.

It may thus be proved that, if the ratio of β′A−Btotal to βA−Btotal is not larger than 1.5, FIG. 7 has a sufficient band as compared to the comparative case of FIG. 6.

β′A−Btotal/βA−Btotal<1.5 (11)

Substituting the equations (9) and (10) into the equation (11), we have the following inequality (12):

(1+3.35×ρ)/(1+2×ρ)<1.5 (12)

Multiplying both sides of the inequality (12) with the denominator thereof, and solving with respect to ρ, the following inequality (13) is obtained.

1+3.5×ρ<1.5+3×ρ

0.5×ρ<0.5

ρ<1 (13)

That is, if the coupling coefficient ρ between non-neighboring nodes is not larger than 1, the inventive configuration of FIG. 7 is lower in the band load.

In addition, with the inventive configuration of FIG. 7, the network may be constructed using a smaller number of the serial buses.

Thus, with the invention of FIG. 7, it is possible to construct a network system more efficient than with the Comparative configuration of FIG. 6.

Although the present invention has so far been described with reference to preferred examples, the present invention is not restricted to the examples. It is to be appreciated that those skilled in the art can change or modify the examples without departing from the spirit and the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A data transmission system comprising:
a plurality of unidirectional serial buses, each transmitting a signal having a synchronization signal superimposed thereon, for use of signal transmission from a transmitting side to a receiving side with a multiplexing degree corresponding to the number of said plurality of unidirectional serial buses; and
a unidirectional serial bus that transmits from said receiving side to said transmitting side a signal for controlling the signal transmission from said transmitting side to said receiving side over said plurality of unidirectional serial buses;
wherein said plurality of unidirectional serial buses from said transmitting side to said receiving side and said unidirectional serial bus from said receiving side to said transmitting side constitute a set of asymmetrical serial buses

2. A communication node apparatus comprising:
a unit that divides single information and performs multiplexed transmission in which divided information are transmitted in parallel from a transmitting side to a receiving side, using a plurality of unidirectional serial buses, each transmitting a signal having a synchronization signal superimposed thereon; and
a unit that transmits a control signal over a unidirectional serial bus, said unidirectional serial bus transmitting said control signal from said receiving side to said transmitting side for controlling the signal transfer from said transmitting side to said receiving side over said plurality of unidirectional serial buses;
wherein said plurality of unidirectional serial buses from said transmitting side to said receiving side and said unidirectional serial bus from said receiving side to said transmitting side constitute a set of asymmetrical serial buses.

3. The communication node apparatus according to claim 2, wherein a plurality of items of data are transmitted in parallel over said plurality of unidirectional serial buses from said transmitting side to said receiving side; and
a response signal to said data transmission is transmitted from said receiving side to said transmitting side over said unidirectional serial bus from said receiving side to said transmitting side.

4. The communication node apparatus according to claim 2, wherein a communication node receiving signals transmitted from said transmitting side over said plurality of unidirectional serial buses comprises
a synchronization detection unit that monitors the signals on the plurality of unidirectional serial buses to detect synchronization slip on the plurality of unidirectional serial buses;
wherein control information for correcting synchronization slip on said plurality of unidirectional serial buses in case said synchronization slip is detected by said synchronization detection unit is notified to said transmitting side over said unidirectional serial bus from said receiving side to said transmitting side.

5. The communication node apparatus according to claim 4, wherein said transmitting side receiving the control information for correcting said synchronization slip comprises
a synchronization unit that synchronizes the signals transmitted from said transmitting side over said plurality of unidirectional serial buses.

6. A network system including a plurality of the communication node apparatuses, each as set forth in claim 2, wherein said plurality of communication node apparatuses are interconnected using said set of asymmetrical serial buses to provide for asymmetrical connection configuration between said communication nodes.

7. The network system according to claim 6, wherein a plurality of items of data are transmitted in parallel over the plurality of unidirectional serial buses from a transmitting side to a receiving side; and
a response signal to said data transmission is transferred from said receiving side to said transmitting side over the unidirectional serial bus from said receiving side to said transmitting side.

8. The network system according to claim 6, wherein a communication node receiving signals transmitted from said transmitting side over said plurality of unidirectional serial buses comprises
a synchronization detection unit that monitors the signals on the plurality of unidirectional serial buses to detect synchronization slip on the plurality of unidirectional serial buses;
wherein control information for correcting synchronization slip on said plurality of unidirectional serial buses in case said synchronization slip is detected by said synchronization detection unit is notified to said transmitting side over said unidirectional serial bus from said receiving side to said transmitting side.

9. The network system according to claim 8, wherein said transmitting side receiving the control information for correcting said synchronization slip comprises
a synchronization unit that synchronizes the signals transmitted from said transmitting side over said plurality of unidirectional serial buses.

10. A data transmission method comprising:
transmitting, by a transmitting side, signals using a plurality of unidirectional serial buses, each transmitting a signal having a synchronization signal superimposed thereon, with a multiplexing degree corresponding to the number of said plurality of unidirectional serial buses from said transmitting side to a receiving side;
transmitting, by said receiving side, on a unidirectional serial bus from said receiving side to said transmitting side, a control signal for controlling the signal transmission over said plurality of unidirectional serial buses from said transmitting side to said receiving side; and
receiving, by said transmitting side, said control signal over said unidirectional serial bus from said receiving side to said transmitting side;
wherein said plurality of unidirectional serial buses from said transmitting side to said receiving side and said unidirectional serial bus from said receiving side to said transmitting side constitute a set of asymmetrical serial buses.

11. The data transmission method according to claim 10, wherein data is transferred from said transmitting side to said receiving side over said plurality of unidirectional serial buses; and
a response signal to said data transmission is transmitted from said receiving side to said transmitting side over said unidirectional serial bus from said receiving side to said transmitting side.

12. The data transmission method according to claim 10, further comprising:
monitoring, by a communication node constituting said receiving side receiving signals transmitted from said transmitting side over said plurality of unidirectional serial buses, the signals on said plurality of unidirectional serial buses; and
notifying, by said communication node, in case of detecting synchronization slip on said plurality of unidirectional serial buses, the control information for correcting the synchronization slip to said transmitting side over said unidirectional serial bus from said receiving side to said transmitting side.

13. The data transmission method according to claim 10, further comprising:
synchronizing, by said transmitting side that has received said control information for correcting the synchronization slip, the signals which are transmitted from said transmitting side over said plurality of unidirectional serial buses.
